(19) United States
(12) Patent Application Publication
(10) Pub. No.: US 2006/0090522 A1
(43) Pub. Date: May 4, 2006

(54) Household machine with a motor

(76) Inventor: Hans-Juergen Kraffzik, Bielefeld (DE)

Correspondence Address: William D. Breneman, Esq.;BRENEMAN & GEORGES, 3150 Commonwealth Avenue, Alexandria, VA, 22305, US

(21) Appl. No.: 11/249,499

(22) Filed: Oct. 14, 2005

(30) Foreign Application Priority Data
Oct. 14, 2004 (DE) 10 2004 050 262.5

(51) Int. Cl. D06F 37/00; D06F 33/00; B08B 3/00

(52) U.S. Cl. 68/3 R; 68/12.16; 134/56 D

(57) ABSTRACT

The invention relates to a household machine, in particular a dishwasher or washing machine, with a motor, wherein at least one mounting unit comprising at least one damping device is provided for adjustably mounting the motor, which is characterized in that the damping device exhibits at least one first damping element with a first damping action, and a second damping element with a second damping action.

The invention relates to a household machine, in particular to a dishwasher or washing machine, with a motor according to the preamble of Claim 1.

Oscillations have been encountered during operation in previous motors, in particular in motors of a circulation pump in a dishwasher. These oscillations or the motor amplitudes and amplitude excursions associated therewith are relatively large, predominantly in a startup phase, given a higher load or power consumption and/or for principal-related reasons in single-phase synchronous motors or their torsional oscillations, which are especially favorable from an economic standpoint, and should be effectively damped or cushioned. In normal operation, these oscillations or amplitudes are comparatively small.

Corresponding mounting devices for these motors are already elastic, and allow the mounted motor to move. However, one disadvantage is the comparatively poor adjustment to variable operating conditions, so that corresponding mounts become impaired or worn over time.

The object of the invention is to propose a household machine with a mounting device for a motor that improves on the prior art.

This object is achieved proceeding from a friction damper of the mentioned kind via the characterizing features of Claims 1 and/or 2. The measures specified in the subclaims enable advantageous embodiments and further developments of the invention.

A friction damper according to the invention is hence characterized in that at least two, in particular different, damping elements and/or an amplitude-dependent damping action of the damping device are provided.

This makes it possible to advantageously realize a two-stage damping process. For example, the first stage is implemented with nearly no damping action or as a free lift. As a result, relatively small amplitude excursions or oscillations of the motor can only be very slightly damped or cushioned, if even at all.

The second stage advantageously provides for a relatively strong damping action. As a result, relatively high amplitude excursions or oscillations of the motor can be effectively damped or cushioned.

A stop or stop surfaces are advantageously provided, in particular for the first damping element. In one advantageous embodiment of the invention, a stop is provided for an amplitude-dependent damping element. Such a stop is used, for example, to introduce the second stage or second damping process, and/or to fix or interrupt the first damping element or first damping process.

In particular, a stop can be secured to the face of the damping element. Such an arrangement makes it easier to pressurize a corresponding additional damping element.

The particularly amplitude-dependent damping element(s) advantageously comprise a material that can be molded at least in an axial direction and/or transverse to the axial direction of the damping action when in the mounted state. For example, this can be accomplished using an elastomer or foaming agent, wherein the material is advantageously selected in such a way as to exhibit self-damping during restoration. The latter feature is used to diminish or even entirely eliminate any resilient effect, and enhance the damping effect of the damping elements. A damping and cushioning material is preferably selected.

An injection-moldable material enables particularly favorable production. For example, an extruded profile can be fabricated, wherein the damping device and/or the damping elements are generated by cutting off individual pieces.

In addition, the damping characteristics can be adjusted as a function of path by correspondingly designing the amplitude-dependent damping elements. Advantageously shaped or profiled moldable elements make it possible to adjust desired force-path curve relationships, for example.

Additional features involving variants of the invention are listed in the subclaims, which can in particular be combined as desired.

The drawing shows an exemplary embodiment, which will be described below based on the sole FIGURE.

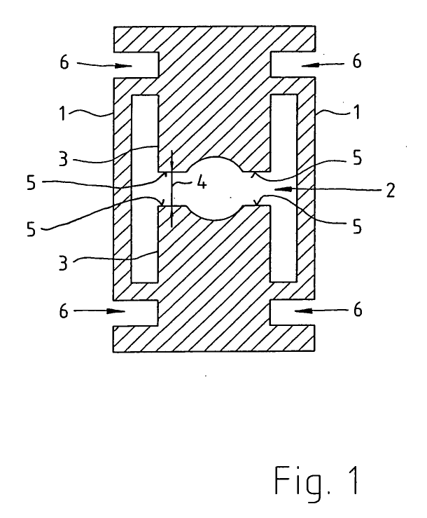

FIG. 1 shows a diagrammatic section through a damping device according to the invention. This example comprises two first damping elements 1 and a second damping element 2 consisting of two damping sections 3. A gap 4 is formed between the two damping sections 3 in the inoperative state. The face of both damping sections 3 exhibits two respective stop surfaces 5, which the respective other damping section 3 strikes given a large enough deflection or amplitude. In other words, the two damping sections 3 strike each other when the amplitude is identical to the gap 4. Up to this amplitude, only the first damping element 1 is engaged.

At an amplitude greater than the gap 4, the second damping element 2 is engaged, thereby realizing a two-stage or amplitude-dependent damping process.

In addition, grooves 6 or recesses 6 are provided for fixation or securing purposes. For example, strips are here engaged, so that the mounting device can be advantageously used for accommodating a motor (not shown in any greater detail).

The damping device according to FIG. 1 preferably consists of a single piece, in particular of a rubbery material, which can advantageously be injection molded, e.g., EPDM or the like.

What is claimed is:

1. A household machine, in particular a dishwasher or washing machine, with a motor, wherein at least one mounting unit enveloping at least one damping device is provided for adjustably accommodating the motor, characterized in that the damping device exhibits at least one first damping element with a first damping action, and a second damping element with a second damping action.

2. The household machine, in particular dishwasher or washing machine, with a motor according to the preamble to claim 1, characterized in that the damping device has at least an amplitude-dependent damping element.

3. The household machine according to claim 1 or 2, characterized in that the damping action of the first damping element is different than the damping action of the second damping element.

4. The household machine according to one of the preceding claims, characterized in that the damping action of the first damping element is smaller than the damping action of the second damping element.

5. The household machine according to one of the preceding claims, characterized in that the damping action of the first damping element is provided at a low amplitude, and the damping action of the second damping element is provided at a high amplitude.

6. The household machine according to one of the preceding claims, characterized in that the damping device has at least one stop for at least one of the damping elements.

7. The household machine according to one of the preceding claims, characterized in that the second damping element has at least one stop surface to stop the first damping element.

8. The household machine according to one of the preceding claims, characterized in that the second damping element has at least two damping sections.

9. The household machine according to one of the preceding claims, characterized in that the two damping sections are at least partially adjustable relative to each other.

10. The household machine according to one of the preceding claims, characterized in that at least a gap is at least partially provided between the two damping sections.

11. The household machine according to one of the preceding claims, characterized in that the two damping sections of the second damping element are connected via the first damping element.

12. The household machine according to one of the preceding claims, characterized in that the damping device is designed as a single structural unit.

13. The household machine according to one of the preceding claims, characterized in that the damping device is essentially made of a single material.

14. The household machine according to one of the preceding claims, characterized in that the material of the damping device dampens and/or cushions.

15. The household machine according to one of the preceding claims, characterized in that the material of the damping device is elastic.

16. The household machine according to one of the preceding claims, characterized in that the damping device essentially consists of a rubbery elastic material.

17. The household machine according to one of the preceding claims, characterized in that the damping device essentially consists of a foam material.

18. The household machine according to one of the preceding claims, characterized in that the damping device essentially consists of an injection moldable material.

19. The household machine according to one of the preceding claims, characterized in that the damping device essentially consists of EPDM.
